(19) United States
(12) Patent Application Publication
(10) Pub. No.: US 2022/0073545 A1
(43) Pub. Date: Mar. 10, 2022

(54) SILANE-MODIFIED DIALLYL BISPHENOL COMPOUND AND PREPARATION METHOD THEREOF

(71) Applicant: Prior Company Limited, Taipei City (TW)

(72) Inventors: Ying-Chen Chen, Taipei City (TW); Cheng-Hsin Tsai, Taipei City (TW)

(73) Assignee: Prior Company Limited, Taipei City (TW)

(21) Appl. No.: 17/069,870

(22) Filed: Oct. 14, 2020

(30) Foreign Application Priority Data
Sep. 10, 2020 (TW) 109131102

(51) Int. Cl. C07F 7/18

(52) U.S. Cl. CPC C07F 7/1892

(57) ABSTRACT

A silane-modified diallyl bisphenol compound and a preparation method thereof are provided. A diallyl bisphenol compound with hydroxyl groups at both ends and a silane with at least one alkoxy group and at least one functional group having a crosslinkable double bond at the ends are reacted, so as to obtain a silane-modified diallyl bisphenol compound with a functional group having a crosslinkable double bond at the end.

### CROSS-REFERENCE TO RELATED APPLICATION

This application claims the priority benefit of Taiwan application serial no. 109131102, filed on Sep. 10, 2020. The entirety of the above-mentioned patent application is hereby incorporated by reference herein and made a part of this specification.

### BACKGROUND OF THE INVENTION

### Field of the Invention

The invention relates to a modified diallyl bisphenol compound and a preparation method thereof, and in particular to a silane-modified diallyl bisphenol compound and a preparation method thereof.

### Description of Related Art

Current printed circuit board (PCB) industry techniques are developing towards high-frequency, high-speed, and high-density packaging regardless of soft or rigid boards, which corresponds to the development trend of light, thin, portable, and multifunctional products. The wiring of a copper clad laminate is becoming denser and thinner between layers, which results in stricter requirements on the impedance characteristics and reliability of transmission circuits, and the assembly and processing accuracy of components. Under the requirements of high frequency, high speed, and miniaturization, high-frequency transmission and low loss materials will fully replace transmission lines. The requirements for circuit substrates need to achieve high heat resistance, low moisture absorption, low dielectric properties, and good flame resistance.

Commonly used low Dk/Df materials for high-frequency and high-speed printed circuit boards mainly include low polarity polyphenylene ether, polytetrafluoroethylene, hydrocarbon resin, polyimide, styrene-maleic anhydride copolymer, etc. In the curing system thereof, various vinyl groups (such as vinyl groups, acrylic groups, methyl acrylic groups) on the resin molecules are mainly used as crosslinking points, and various multifunctional vinyl crosslinking agents are used in the adhesive formula. Moreover, via the addition of peroxide in the adhesive formula, the adhesive formula starts a cross-linking reaction during a hot press process, thereby curing the adhesive formula. In particular, polyphenylene ether has higher glass transition temperature, lower Dk/Df, and lower water absorption, and is currently a material that has attracted attention in the field of high-frequency and high-speed electronic research.

Regarding the preparation of a polyphenylene ether resin-based laminate, polyphenylene ether resin is usually combined with a monomer compound of triallyl isocyanurate (TAIC) or triallyl cyanurate (TAC) as a crosslinking agent. However, TAIC has a low boiling point and is readily volatilized from the resin composition formula during the manufacturing process of the laminate, resulting in distortion of the formula and inconsistent characteristics of the final electronic material. Although the boiling point of TAC is higher, the small enol molecules produced after thermal decomposition greatly increases Dk and Df, which is not conducive to the electrical properties after curing.

Based on the above, a small molecule multifunctional crosslinking agent is developed that has a higher boiling point, is thermally stable, and has low polarity. The small molecule multifunctional crosslinking agent may be used with polyphenylene ether, polytetrafluoroethylene, hydrocarbon resin, and other resins to provide a thermosetting resin formulation system that may be used for 5G materials, which is an urgent development object for those skilled in the art.

### SUMMARY OF THE INVENTION

The invention provides a silane-modified diallyl bisphenol compound and a preparation method thereof. Via the preparation method of the invention, a silane-modified diallyl bisphenol compound with a functional group having a cross-linkable double bond at the end is obtained to obtain better performance.

A silane-modified diallyl bisphenol compound of the invention has a structure represented by formula (1):

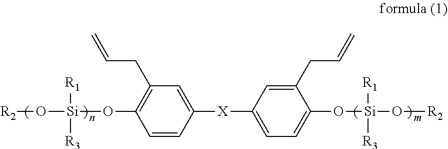

in formula (1), X is a straight or branched C1 to C6 alkyl group, a cycloalkyl group, or a sulfonyl group, R1 is a straight or branched C1 to C6 alkyl group or aryl group, R2 is a C1 to C6 alkyl group, R3 is a functional group having a crosslinkable double bond, and n+m is a positive integer of 1 to 8.

In an embodiment of the invention, the functional group having the crosslinkable double bond includes an allyl group, a vinyl group, an acrylate, or a methacrylate.

In an embodiment of the invention, n+m is 2 or 3.

A silane-modified diallyl bisphenol compound of the invention has a structure represented by formula (2):

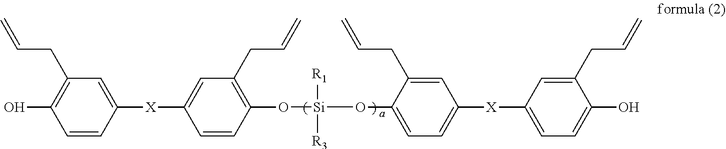

in formula (2), X is a straight or branched C1 to C6 alkyl group, a cycloalkyl group, or a sulfonyl group, R1 is a straight or branched C1 to C6 alkyl group or aryl group, R3 is a functional group having a crosslinkable double bond, and a is a positive integer of 1 to 4.

In an embodiment of the invention, the functional group having the crosslinkable double bond includes an allyl group, a vinyl group, an acrylate, or a methacrylate.

A preparation method of a silane-modified diallyl bisphenol compound of the invention is used for preparing the silane-modified diallyl bisphenol compound above, and a synthesis reaction formula thereof is represented by reaction formula (1):

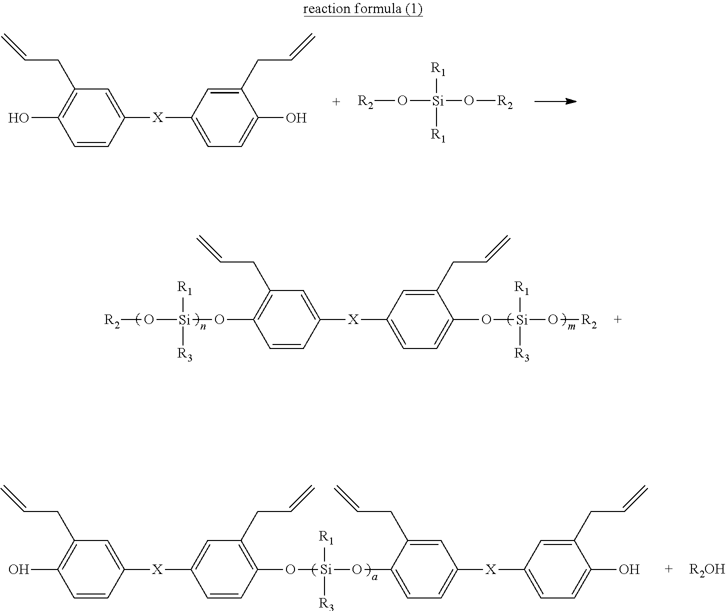

in reaction formula (1), X is a straight or branched C1 to C6 alkyl group, a cycloalkyl group, or a sulfonyl group, R1 is a straight or branched C1 to C6 alkyl group or aryl group, R2 is a C1 to C6 alkyl group, R3 is a functional group having a crosslinkable double bond, n+m is a positive integer of 1 to 8, and a is a positive integer of 1 to 4.

In an embodiment of the invention, the functional group having the crosslinkable double bond includes an allyl group, a vinyl group, an acrylate, or a methacrylate.

In an embodiment of the invention, n+m is 2 or 3.

In an embodiment of the invention, a reaction temperature of reaction formula (1) is 100° C. to 180° C.

In an embodiment of the invention, calculated based on a mole ratio of a hydroxyl group of a diallyl bisphenol compound to an alkoxy group containing a dialkoxysilane with a functional group having a crosslinkable double bond, a ratio of the diallyl bisphenol compound to the dialkoxysilane with the functional group having the crosslinkable double bond is 1:0.5 to 1:4.0.

In an embodiment of the invention, an amount of a catalyst of reaction formula (1) is 500 ppm to 5000 ppm relative to a weight of the diallyl bisphenol compound.

Based on the above, the invention provides a silane-modified diallyl bisphenol compound and a preparation method thereof. The resulting silane-modified diallyl bisphenol compound has at least two reactive double bonds in structure that may be cross-linked with modified polyphenylene ether to further increase crosslink density to form a cured resin with high crosslink density. Therefore, in addition to being used on a polyphenylene ether resin laminate, the silane-modified diallyl bisphenol compound may also be used as a raw material to compound with a bismaleimide resin to form a thermosetting resin composition with low shrinkage, high Tg, high heat resistance, and low dielectric properties.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an IR spectrum of the silane-modified diallyl bisphenol compound of Example 2.

### DESCRIPTION OF THE EMBODIMENTS

In the following, the embodiments of the invention are described in detail. However, the embodiments are exemplary, and the invention is not limited thereto.

In the present specification, a range represented by “a numerical value to another numerical value” is a schematic representation for avoiding listing all of the numerical values in the range in the specification. Therefore, the recitation of a specific numerical range covers any numerical value in the numerical range and a smaller numerical range defined by any numerical value in the numerical range, as is the case with the any numerical value and the smaller numerical range stated explicitly in the specification.

The invention provides a silane-modified diallyl bisphenol compound having a structure represented by formula (1):

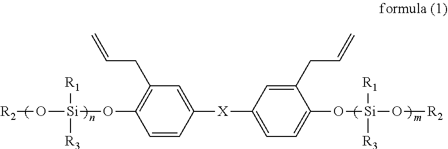

in formula (1), X is a straight or branched C1 to C6 alkyl group, a cycloalkyl group, or a sulfonyl group, R1 is a straight or branched C1 to C6 alkyl group or aryl group, R2 is a C1 to C6 alkyl group, R3 is a functional group having a crosslinkable double bond, n+m is a positive integer of 1 to 8, and n+m is preferably 2 or 3.

In more detail, in formula (1), R3 is a functional group having a crosslinkable double bond, and the functional group having the crosslinkable double bond may include an allyl group, a vinyl group, an acrylate, or a methacrylate, but the invention is not limited thereto. In addition, it should be noted that in formula (1), R3 may or may not contain an oxygen atom. If R3 contains an oxygen atom, for example, the oxygen atom may be attached first, and then the functional group having the crosslinkable double bond may be attached.

In addition to the silane-modified diallyl bisphenol compound represented by formula (1) above, the invention also provides another silane-modified diallyl bisphenol compound having a structure represented by formula (2):

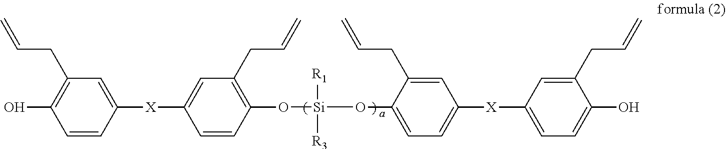

in formula (2), X is a straight or branched C1 to C6 alkyl group, a cycloalkyl group, or a sulfonyl group, R1 is a straight or branched C1 to C6 alkyl group or aryl group, R3 is a functional group having a crosslinkable double bond, and a is a positive integer of 1 to 4.

In more detail, in formula (2), R3 is a functional group having a crosslinkable double bond, and the functional group having the crosslinkable double bond may include an allyl group, a vinyl group, an acrylate, or a methacrylate, but the invention is not limited thereto. In addition, it should be noted that in formula (2), R3 may or may not contain an oxygen atom. If R3 contains an oxygen atom, for example, the oxygen atom may be attached first, and then the functional group having the crosslinkable double bond may be attached.

At the same time, the invention also provides a preparation method of a silane-modified diallyl bisphenol compound for preparing the silane-modified diallyl bisphenol compounds represented by formula (1) and formula (2), and the synthesis reaction formula thereof is represented by reaction formula (1):

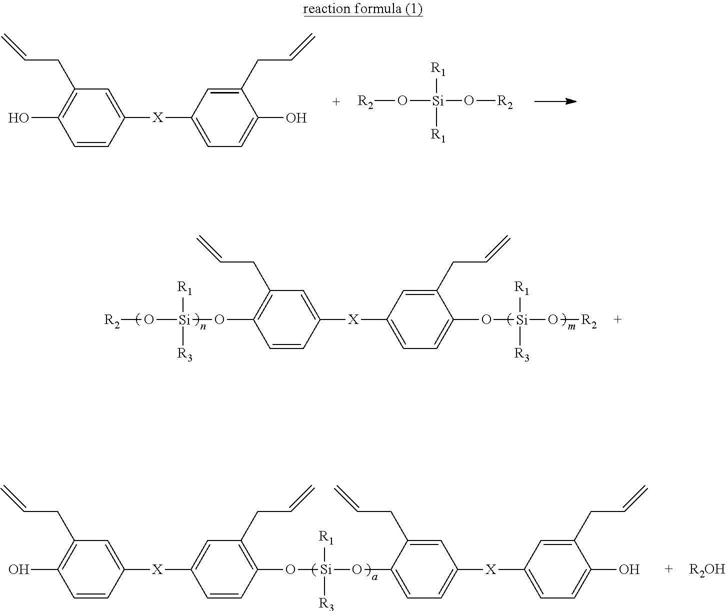

in reaction formula (1), X is a straight or branched C1 to C6 alkyl group, a cycloalkyl group, or a sulfonyl group, R1 is a straight or branched C1 to C6 alkyl group or aryl group, R2 is a C1 to C6 alkyl group, R3 is a functional group having a crosslinkable double bond, n+m is a positive integer of 1 to 8, n+m is preferably 2 or 3, and a is a positive integer of 1 to 4.

In more detail, in reaction formula (1), R3 is a functional group having a crosslinkable double bond, and the functional group having the crosslinkable double bond may include an allyl group, a vinyl group, an acrylate, or a methacrylate, but the invention is not limited thereto. In addition, it should be noted that in reaction formula (1), R3 may or may not contain an oxygen atom. If R3 contains an oxygen atom, for example, the oxygen atom may be attached first, and then the functional group having the crosslinkable double bond may be attached.

As shown in the above reaction formula (1), in the invention, a dealcoholization reaction is performed at high temperature under the action of a catalyst mainly with a diallyl bisphenol compound with hydroxyl groups at both ends and a silane with at least one alkoxy group and at least one functional group having a crosslinkable double bond at the ends to obtain a silane-modified diallyl bisphenol compound with a functional group having a cross-linkable double bond at the end (that is, the silane-modified diallyl bisphenol compounds represented by formula (1) and formula (2)).

In the present embodiment, the reaction temperature of reaction formula (1) is, for example, 100° C. to 180° C., and is preferably, for example, 130° C. to 160° C., and the reaction time is, for example, 2 hours to 15 hours. In more detail, the diallyl bisphenol compound and the silane with the functional group having the crosslinkable double bond may be placed at the bottom of a reaction tank to react, or the diallyl bisphenol compound may be placed at the bottom of the reaction tank, and the silane with the functional group having the crosslinkable double bond is fed in a dropwise addition manner for reaction. The dropwise addition time is, for example, 1 hour to 10 hours. Calculated based on a mole ratio of a hydroxyl group of a diallyl bisphenol compound to an alkoxy group containing a dialkoxysilane with a functional group having a crosslinkable double bond, a ratio of the diallyl bisphenol compound to the dialkoxysilane with the functional group having the crosslinkable double bond is, for example, 1:0.5 to 1:4.0.

In the present embodiment, relative to the weight of the diallyl bisphenol compound, the amount of the catalyst of reaction formula (1) is, for example, 500 ppm to 5000 ppm. The type of the catalyst may include, but is not limited to, an acid catalyst, a base catalyst, a metal compound catalyst, an ester catalyst, or a combination thereof, and is, preferably, for example, ethyl triphenyl phosphine chloride (ETPPCl), ethyl triphenyl phosphine bromide (ETPPBr), ethyl triphenyl phosphine iodide (ETPPI), ethyl triphenyl phosphine acetate (ETPPAAc), tetrabutyl ammonium bromide (TBAB), triphenyl phosphine (TPP), or tetra-n-butyl ammonium acetate (TBAAc), but the invention is not limited thereto.

In reaction formula (1), the alkoxysilane containing a functional group having a crosslinkable double bond used in the invention is represented by formula (A):

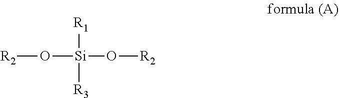

as described above, in formula (A), R1 is a straight or branched C1 to C6 alkyl group or aryl group, R2 is a C1 to C6 alkyl group, R3 is a functional group having a crosslinkable double bond, and the functional group having the crosslinkable double bond may include an allyl group, a vinyl group, an acrylate, or a methacrylate, but the invention is not limited thereto. In the present embodiment, specific examples of formula (A) may include methyl vinyl dimethoxy silane, methyl vinyl diethoxy silane, allyl methyl dimethoxy silane, 1-allyl-2,2-dimethoxy-1,2-azasilylcyclopentane, or a combination thereof, but the invention is not limited thereto. The chemical structural formulas of specific cases are as follows:

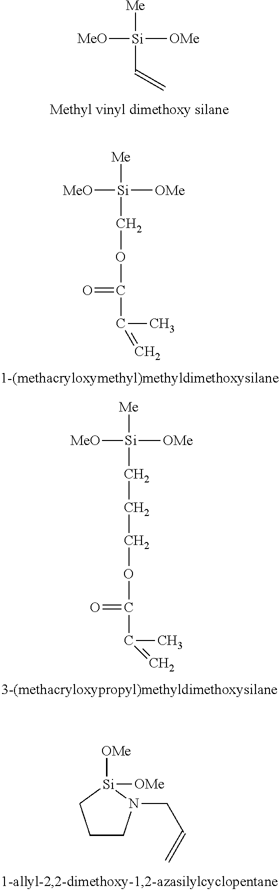

Hereinafter, the silane-modified diallyl bisphenol compound provided by the invention is described in detail with experimental examples. However, the following experimental examples are not intended to limit the invention.

### EXPERIMENTAL EXAMPLES

In order to prove that the preparation method provided by the invention may obtain a silane-modified diallyl bisphenol compound, these experimental examples are specifically made as follows.

### Example 1

50.19 g of diallyl bisphenol A (Daiwa Kasei Industry, purity>90%), 0.042 g of ethyl triphenyl phosphine acetate, and 51.64 g of methyl vinyl dimethoxy silane (XL12, Wacker, Germany) were added in a reaction tank and evenly stirred and heated to 110° C. for 7 hours to obtain a silane-modified diallyl bisphenol compound.

### Example 2

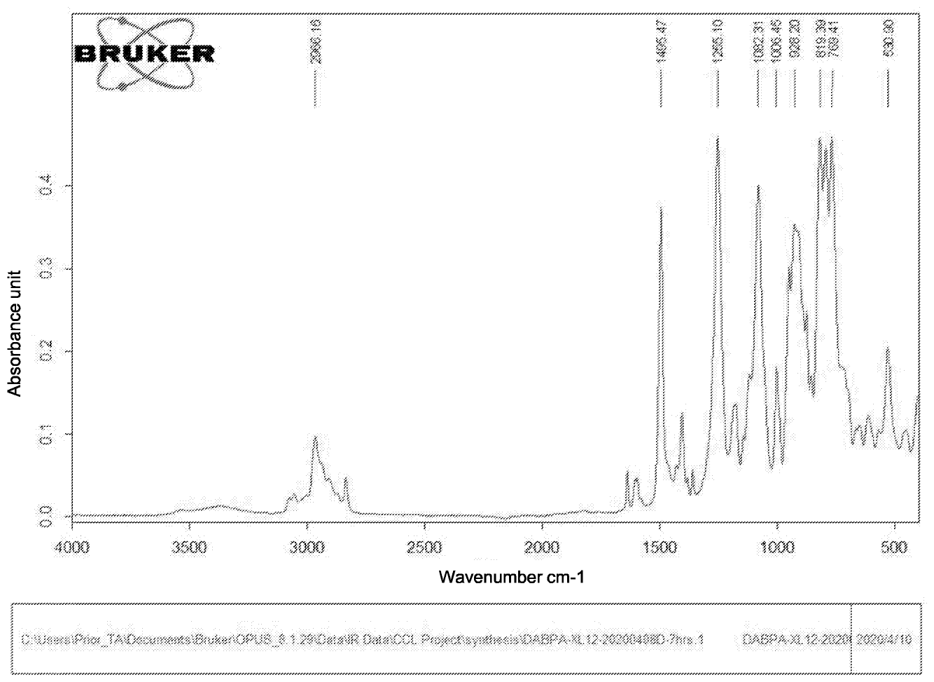

72.3 g of diallyl bisphenol A (Daiwa Kasei Industry, purity>90%) was placed in a four-neck round bottom flask, stirred, and heated to 145° C. Then, 0.125 g of tetra-n-butylammonium acetate was added, and after evenly stirring, 58.3 g of methyl vinyl dimethoxysilane (XL12, Wacker, Germany) was added dropwise into a reaction tank. The dropwise addition time was 3 hours, and the methanol liquid produced during the reaction was collected. The total reaction time was 7 hours, and a silane-modified diallyl bisphenol compound was obtained. FIG. 1 is an IR spectrum of the silane-modified diallyl bisphenol compound of Example 2. The raw material diallyl bisphenol A had a strong OH group absorption peak at 3422 cm⁻¹, but the absorption peak disappeared on the IR spectrum of the product, and the product had a strong Si—O-Ph group absorption peak at 928 cm⁻¹. From the above, it may be proved that the silane-modified diallyl bisphenol compound was successfully synthesized.

### Example 3

72.3 g of diallyl bisphenol A (Daiwa Kasei Industry, purity>90%) was placed in a four-neck round bottom flask, stirred, and heated to 145° C. Then, 0.133 g of tetra-n-butylammonium bromide was added, and after evenly stirring, 58.3 g of methyl vinyl dimethoxysilane (XL12, Wacker, Germany) was added dropwise into a reaction tank. The dropwise addition time was 5 hours, and the methanol liquid produced during the reaction was collected. The total reaction time was 8 hours, and a silane-modified diallyl bisphenol compound was obtained.

The raw material formulas and reaction conditions of Example 1 to Example 3 are summarized in Table 1 below:

TABLE 1

| | | | Methyl vinyl | | Mole ratio of | | |
|---|---|---|---|---|---|---|---|
| | Diallyl | | dimethoxy | | diallyl | | |
| | bisphenol | | silane | | bisphenol | | Reaction |
| | A | | (XL12) | | A/XL12 | Catalyst | temperature |
| Example 1 | 50.19 | g | 51.64 | g | 1:2.67 | Ethyltriphenylphosphonium | 110° C. |
| | | | | | | acetate | |
| Example 2 | 72.3 | g | 58.3 | g | 1:2.09 | Tetra-n-butylammonium | 145° C. |
| | | | | | | acetate | |
| Example 3 | 72.3 | g | 58.3 | g | 1:2.09 | Tetra-n-butylammonium | 145° C. |
| | | | | | | bromide | |

Based on the above, the invention provides a silane-modified diallyl bisphenol compound as a small molecule multifunctional crosslinking agent. The silane-modified diallyl bisphenol compound contains at least two functional groups having a crosslinkable double bond and has higher boiling point, is thermally stable, and low in polarity, and may be used with polyphenylene ether, polytetrafluoroethylene, hydrocarbon resin, and other resins to provide a thermosetting resin formulation system that may be used for 5G materials.

In addition, a preparation method of a silane-modified diallyl bisphenol compound is provided. A diallyl bisphenol compound with hydroxyl groups at both ends and a silane with at least one alkoxy group and at least one functional group having a crosslinkable double bond at the ends are reacted, so as to obtain a silane-modified diallyl bisphenol compound with a functional group having a crosslinkable double bond at the end. Since this reaction may produce a stable Si—O bond on the structure of the diallyl bisphenol compound, the Si—O bond has very high bond energy and therefore has characteristics such as good heat resistance, flame retardancy, low water absorption, weather resistance, and corrosion resistance. At the same time, due to the large bond angle of the Si—O bond, the Si—O bond may be freely rotated, and therefore the flexibility of the molecule is better, thus providing excellent toughness.

Moreover, the silane-modified diallyl bisphenol compound of the invention introduces a silane with low-polarity and lubricating properties. Therefore, the viscosity of the diallyl bisphenol compound itself may be further reduced, so that the operation of the crosslinking agent is more convenient. A silane-modified diallyl bisphenol compound of the invention has at least two reactive double bonds in structure that may be cross-linked with modified polyphenylene ether to further increase crosslink density to form a cured resin with high crosslink density. Therefore, in addition to being used on a polyphenylene ether resin laminate, the silane-modified diallyl bisphenol compound may also be used as a raw material to compound with a bismaleimide resin to form a thermosetting resin composition with low shrinkage, high Tg, high heat resistance, and low dielectric properties.

1. A silane-modified diallyl bisphenol compound having a structure represented by formula (1): 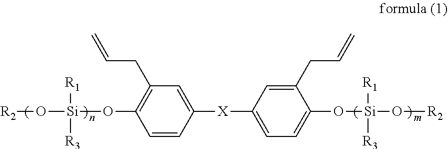
in formula (1), X is a straight or branched C1 to C6 alkyl group, a cycloalkyl group, or a sulfonyl group, R1 is a straight or branched C1 to C6 alkyl group or aryl group, R2 is a C1 to C6 alkyl group, R3 is a functional group having a crosslinkable double bond, and n+m is a positive integer of 1 to 8.

2. The silane-modified diallyl bisphenol compound of claim 1, wherein the functional group having the crosslinkable double bond comprises an allyl group, a vinyl group, an acrylate, or a methacrylate.

3. The silane-modified diallyl bisphenol compound of claim 1, wherein n+m is 2 or 3.

4. A silane-modified diallyl bisphenol compound having a structure represented by formula (2): 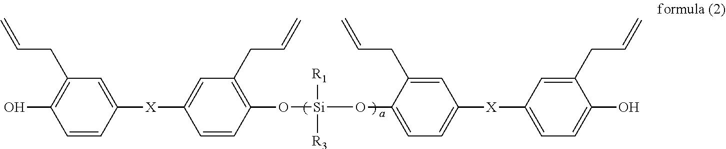
in formula (2), X is a straight or branched C1 to C6 alkyl group, a cycloalkyl group, or a sulfonyl group, R1 is a straight or branched C1 to C6 alkyl group or aryl group, R3 is a functional group having a crosslinkable double bond, and a is a positive integer of 1 to 4.

5. The silane-modified diallyl bisphenol compound of claim 4, wherein the functional group having the crosslinkable double bond comprises an allyl group, a vinyl group, an acrylate, or a methacrylate.

6. A preparation method of a silane-modified diallyl bisphenol compound, wherein a synthesis reaction formula thereof is represented by reaction formula (1): 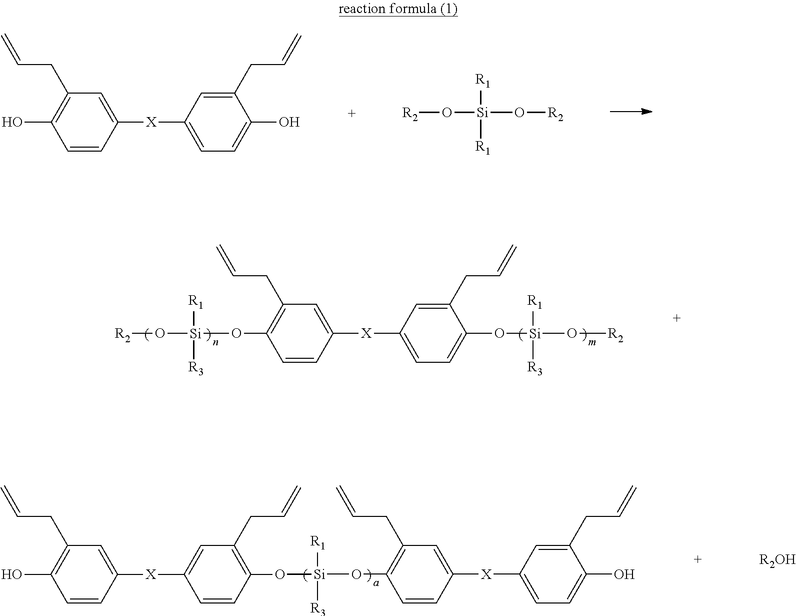
in reaction formula (1), X is a straight or branched C1 to C6 alkyl group, a cycloalkyl group, or a sulfonyl group, R1 is a straight or branched C1 to C6 alkyl group or aryl group, R2 is a C1 to C6 alkyl group, R3 is a functional group having a crosslinkable double bond, n+m is a positive integer of 1 to 8, and a is a positive integer of 1 to 4.

7. The preparation method of the silane-modified diallyl bisphenol compound of claim 6, wherein the functional group having the crosslinkable double bond comprises an allyl group, a vinyl group, an acrylate, or a methacrylate.

8. The preparation method of the silane-modified diallyl bisphenol compound of claim 6, wherein n+m is 2 or 3.

9. The preparation method of the silane-modified diallyl bisphenol compound of claim 6, wherein a reaction temperature of reaction formula (1) is 100° C. to 180° C.

10. The preparation method of the silane-modified diallyl bisphenol compound of claim 6, wherein calculated based on a mole ratio of a hydroxyl group of a diallyl bisphenol compound to an alkoxy group containing a dialkoxysilane with a functional group having a crosslinkable double bond, a ratio of the diallyl bisphenol compound to the dialkoxysilane with the functional group having the crosslinkable double bond is 1:0.5 to 1:4.0.

11. The preparation method of the silane-modified diallyl bisphenol compound of claim 6, wherein an amount of a catalyst of reaction formula (1) is 500 ppm to 5000 ppm relative to a weight of the diallyl bisphenol compound.
